(19) United States
(12) Patent Application Publication
(10) Pub. No.: US 2014/0009096 A1
(43) Pub. Date: Jan. 9, 2014

(54) POWER CONVERSION DEVICE

(71) Applicants: Akira Imanaka, Chiyoda-ku (JP); Masaya Harakawa, Chiyoda-ku (JP)

(72) Inventors: Akira Imanaka, Chiyoda-ku (JP); Masaya Harakawa, Chiyoda-ku (JP)

(73) Assignee: MITSUBISHI ELECTRIC CORPORATION, Chiyoda-ku, Tokyo (JP)

(21) Appl. No.: 14/000,255

(22) PCT Filed: Mar. 10, 2011
(86) PCT No.: PCT/JP2011/001403

§ 371 Date: Sep. 20, 2013

(51) Int. Cl. H02M 5/458

(52) U.S. Cl. CPC H02M 5/458
USPC 318/494; 363/37

(57) ABSTRACT

A power conversion device is provided in which destruction of a switching element can be avoided by preventing an excessive current from flowing into the switching element of a main circuit when, for example, a power supply for the power conversion device is interrupted. The power conversion device including a first switch unit in which a plurality of switching elements are series-connected is characterized by including, in the plurality of switching elements, at least one or more switching elements whose gate voltage thresholds are no more than a predetermined value and at least one or more switching elements whose gate voltage thresholds are more than the predetermined value.

### TECHNICAL FIELD

The present invention relates to power conversion devices and in particular, to switching elements and peripheral circuits thereof.

### BACKGROUND ART

There is disclosed, for example, in Patent Document 1 a booster chopper circuit in which a wide bandgap semiconductor using materials such as SiC and GaN is employed as a switching element in a conventional power conversion device and in which a high-speed switching characteristic of the semiconductor is utilized.

Also, an example of a three-phase inverter in which an SiC device is used as a switching element is disclosed in Patent Document 2, and an example of a three-phase three-level converter in which an SiC device is used as a switching element is disclosed in Patent Document 3. In addition, an example in which a wide bandgap semiconductor using materials such as SiC and GaN is employed in a PWM converter for obtaining a DC voltage from an AC power source is disclosed in Patent Document 4.

### PRIOR ART DOCUMENTS

### Patent Documents

Patent Document 1: Japanese Unexamined Patent Application Publication No. 2006-67696

Patent Document 2: Japanese Unexamined Patent Application Publication No. 2000-224867

Patent Document 3: Japanese Unexamined Patent Application Publication No. 2001-112260

Patent Document 4: Japanese Unexamined Patent Application Publication No. 200861403

### SUMMARY OF THE INVENTION

Problem that the Invention is to Solve

Owing to a low switching loss, an SiC-MOS transistor has generally a feature that enables high-speed switching. Thus, if an SiC-MOS transistor is employed, for example, in a power conversion device, it is possible to downsize a filter or a reactor for limiting current in the power conversion device. Also, if employed as an inverter for driving a motor, it is possible to reduce a motor loss.

However, an SiC-MOS transistor has disadvantages that a conduction loss increases due to an increase of on-resistance of the transistor unless an SiC-MOS transistor chip is so designed that a gate threshold voltage becomes low. In order to deal with the above described disadvantages, such a chip is often designed so that its gate threshold voltage will be set to be around zero voltage or its gate threshold voltage is set to be no more than zero voltage, as what is called normally-on.

If an SiC-MOS transistor whose gate threshold voltage is designed to be no more than zero voltage is employed as an switching element in a power conversion device, it is necessary to apply a negative voltage continuously as a gate voltage to the transistor in order to make the SiC-MOS transistor OFF. Even if an SiC-MOS transistor whose gate threshold voltage is designed to be a positive voltage is employed, the transistor may be turned on by malfunction due to influence of external noise, etc. when its gate threshold voltage is around zero voltage. Therefore, in order to prevent the transistor from being turned on by the malfunction, it is necessary to apply a negative voltage continuously as a gate voltage to the transistor, similar to the above described case in which the SiC-MOS transistor whose gate threshold voltage is designed to be no more than zero voltage is employed.

In a conventional power conversion device cited in the above examples, if a power source breaker connected to the power conversion device is interrupted, or a control circuit voltage for controlling a main circuit of a switch is interrupted due to a power failure, etc. before a main circuit voltage of the switch is decreased, it is impossible to continuously apply a negative voltage as a gate voltage and the gate voltage becomes zero. In such a case, if the main circuit voltage accumulated in a capacitor, etc. is applied to a portion between a drain and a source of the SiC-MOS transistor, the SiC-MOS transistor, which is intrinsically to be OFF, becomes ON. Thus, because an excessive current including a capacitor discharge current flows through the SiC-MOS transistor, the SiC-MOS transistor is destroyed, which has been a problem.

Furthermore, when the power conversion device is powered on, if a voltage is applied to a portion between a drain and a source of the SiC-MOS transistor due to an increase of the main circuit voltage before a control circuit voltage increases to a value enough for enabling a control circuit to operate, the SiC-MOS transistor becomes ON since the gate voltage is zero voltage. Thus, because an excessive current including a capacitor discharge current flows through the SiC-MOS transistor, similar to the above described case, the SiC-MOS transistor is destroyed, which has been a problem.

In addition, other than the above described problem that the excessive current flows through the SiC-MOS transistor, in a conventional power conversion device using an SiC-MOS transistor, if an earth fault accident, etc. occurs, the SiC-MOS transistor becomes ON although the gate voltage of the SiC-MOS transistor is in a zero state. Thus, because an excessive earth fault current flows through the SiC-MOS transistor, the SiC-MOS transistor is destroyed, which has been a problem.

The present invention is made considering the above described problems, and is to provide a power conversion device in which destruction of a switching element can be avoided by preventing an excessive current from flowing into the switching element when a power supply for a control circuit for controlling the switching element is interrupted, or even when a control circuit voltage is low while a main circuit voltage is applied, during a control power source voltage increasing process, etc. after powered on.

Means for solving the Problem

power conversion device is characterized in that a switch unit comprised by pairing a first switching element whose gate voltage threshold is a first predetermined value and a second switching element whose gate voltage threshold is a second predetermined value which is higher than the first predetermined value, is connected to a DC power input terminal for inputting a DC voltage to the switch unit (claim 1).

The power conversion device is characterized in that a third switching element is provided which is series-connected to the switch unit and whose gate voltage is lower than the second predetermined value, and a junction between the switch unit and the third switching element is connected to a load (claim 2).

The power conversion device is characterized in that one of junctions between the first switching element and the second switching element is connected to a load (claim 3).

The power conversion device is characterized in that the load is a motor, an AC power source, or a reactor (claim 4).

The power conversion device is characterized in that it is a booster chopper circuit which has an output terminal connected to a load, in which a circuit where the switch unit and a diode are series-connected and the output terminal are parallel-connected, and in which a reactor is connected to a junction between the diode and the switch unit (claim 5).

The power conversion device is characterized in that a first control unit is provided which controls a gate signal for switching elements so that the number of times for switching the first switching element will be larger than the number of times for switching the second switching element (claim 6).

The power conversion device is characterized in that gate drive signals for the first switching element and the second switching element are controlled by the first control unit so that, when a DC voltage enough for normally operating is inputted, an input signal for the first switching element will be set to be always-on and an input signal for a gate terminal of the second switching element is pulse width modulated (claim 7).

The power conversion device is characterized in that it is comprised with a switch circuit wherein a plurality of switch units are parallel-connected to a DC power input terminal that applies a DC voltage to the plurality of switch units, each of which has a plurality of first switching elements, which are series-connected, whose gate voltage thresholds are a first predetermined value; a control unit for controlling the first switching elements to be turned on or off; and a second switching element, located between the switch circuit and the DC power input terminal, whose gate voltage threshold is a second predetermined value which is higher than the first predetermined value, wherein any one of junctions between the plurality of first switching elements which are series-connected, is connected to a load (claim 8).

The power conversion device is characterized in that the second switching element is connected between a positive electrode side of the switch circuit and a positive electrode side of the DC power input terminal (claim 9).

The power conversion device is characterized in that the second switching element is connected between a negative electrode side of the switch circuit and a negative electrode side of the DC power input terminal (claim 10).

The power conversion device is characterized in that the second switching elements are connected between a positive electrode side of the switch circuit and a positive electrode side of the DC power input terminal, and between a negative electrode side of the switch circuit and a negative electrode side of the DC power input terminal (claim 11).

The power conversion device is characterized in that the control unit, after turning on the second switching element, performs control to turn on or off the first switching element so that a desired voltage will be applied to the load (claim 12).

The power conversion device is characterized in that it is comprised with a switch circuit wherein a plurality of switch units are parallel-connected to a DC power input terminal that applies a DC voltage to the plurality of switch units, in each of which a first switching element whose gate voltage threshold is a first predetermined value and a second switching element whose gate voltage threshold is a second predetermined value which is higher than the first predetermined value are series-connected; and a control unit for controlling the first switching elements and the second switching elements to be turned on or off, wherein any one of junctions between the first switching elements and the second switching elements which are series-connected is connected to a load (claim 13).

The power conversion device is characterized in that, in the switch unit, the first switching element is connected to a positive electrode side of the DC power input terminal and the second switching element is connected to a negative electrode side of the DC power input terminal (claim 14).

The power conversion device is characterized in that, in the switch unit, the first switching element is connected to a negative electrode side of the DC power input terminal and the second switching element is connected to a positive electrode side of the DC power input terminal (claim 15).

The power conversion device is characterized in that a third switching element whose gate voltage threshold is a third predetermined value which is higher than the first predetermined value is provided between a positive electrode side of the switch circuit and a positive electrode side of the DC power input terminal (claim 16).

The power conversion device is characterized in that a third switching element whose gate voltage threshold is a third predetermined value which is higher than the first predetermined value is provided between a negative electrode side of the switch circuit and a negative electrode side of the DC power input terminal (claim 17).

The power conversion device is characterized in that third switching elements whose gate voltage threshold is a third predetermined value which is higher than the first predetermined value are provided between a positive electrode side of the switch circuit and a positive electrode side of the DC power input terminal, and between a negative electrode side of the switch circuit and a negative electrode side of the DC power input terminal (claim 18).

The power conversion device is characterized in that the control unit, after turning on the second switching element, performs control to turn on or off the first switching element so that a desired voltage will be applied to the load (claim 19).

The power conversion device is characterized in that a diode is anti-parallel connected to the second switching element (claim 20).

The power conversion device is characterized in that a diode is anti-parallel connected to the third switching element (claim 21).

The power conversion device is characterized in that the second switching element and the third switching element are switching elements whose gate voltage thresholds are higher than 2 volts (claim 22).

The power conversion device is characterized in that the first switching element is a switching element whose gate threshold voltage is no more than 2 volts (claim 23).

The power conversion device is characterized in that the second switching element and the third switching element are IGBTs or MOSFETs made of silicon (claim 24).

The power conversion device is characterized in that the first switching element is a unipolar switching device of SiC (silicon carbide) or GaN (gallium nitride) which is a wide bandgap semiconductor (claim 25).

Advantageous Effects of the Invention

As described above, in a power conversion device according to the present invention, a configuration is employed such that a switch unit comprised by pairing a first switching element whose gate voltage threshold is a first predetermined value and a second switching element whose gate voltage threshold is a second predetermined value which is higher than the first predetermined value, is connected to a DC power input terminal for inputting a DC voltage to the switch unit. Therefore, when a power supply for a circuit for controlling the first switching element and the second switching element is interrupted, out of the switching elements, the second switching element whose gate voltage threshold is the second predetermined value which is higher than the first predetermined value becomes OFF, even if the first switching element whose gate voltage threshold is the first predetermined value cannot become OFF. As a result, if the power supply for the control circuit is interrupted, destruction of the switching elements can be avoided by preventing an excessive current from flowing into the first switching element and the second switching element.

A configuration is employed in the power conversion device such that a third switching element is provided which is series-connected to the switch unit and whose gate voltage is lower than the second predetermined value, and a junction between the switch unit and the third switching element is connected to a load. Therefore, even if a power supply for a circuit for controlling the switching elements in the switch unit and the third switching element is interrupted, current is surely interrupted by the second switching element in the switch unit. In addition, an arbitrary voltage can be applied to the load with low loss by the switch unit and the third switching element, which is series-connected to the switch unit, whose gate voltage threshold is lower than the second predetermined value.

Because a configuration is employed such that one of junctions between the first switching elements and the second switching elements is connected to the load, an arbitrary voltage can be applied to the load with low loss by the switching element whose gate voltage threshold is lower than the predetermined value without increasing the number of switching elements.

In the power conversion device, a booster chopper circuit is employed which has an output terminal connected to the load; in which a circuit where the switch unit and a diode are series-connected, and the output terminal are parallel-connected; and in which a reactor is connected to a junction between the diode and the switch unit. Therefore, a booster chopper circuit capable of an operation with low loss or with high carrier frequency can be configured with high reliability.

Because a configuration is employed such that a first control unit is provided which controls a gate signal for the switching element so that the number of times for switching the first switching element will be larger than the number of times for switching the second switching element, the power conversion device can be operated with lower loss.

In the first control unit, gate drive signals for the first switching element and the second switching element are controlled so that, when a DC voltage enough for normally operating is inputted, an input signal for the first switching element will be set to be always-on and an input signal for a gate terminal of the second switching element is pulse width modulated. Therefore, destruction of the switching elements can be avoided by preventing an excessive current, caused by simultaneously turning on both of the first switching element and the second switching element erroneously, from flowing into the first switching element and the second switching element when, for example, the power conversion device is powered on.

A configuration is employed by providing a switch circuit wherein a plurality of switch units are parallel-connected to a DC power input terminal that applies a DC voltage to the plurality of switch units, each of which has a plurality of first switching elements, which are series-connected, whose gate voltage thresholds are a first predetermined value; a control unit for controlling the first switching elements to be turned on or off; and a second switching element whose gate voltage threshold is a second predetermined value which is higher than the first predetermined value located between the switch circuit and the DC power input terminal, and by connecting any one of junctions between the plurality of first switching elements which are series-connected, to a load. Therefore, by simply adding a single switching element, a configuration can be obtained that enables to prevent an excessive current from flowing through the plurality of switching elements, even if a power supply for the control circuit is interrupted when a control power source voltage is decreased.

Because a diode is anti-parallel connected to the second switching element whose gate voltage threshold is the second predetermined value and a third switching element whose gate voltage threshold is lower than the second predetermined value, a surge voltage generated by switching can be prevented. In addition, when a load of the power conversion device is a motor, etc., since energy accumulated in a load side inductance can be regenerated as DC power, generation of an excessive voltage on the second switching element and the third switching element can be prevented.

If a switching element whose gate threshold voltage is no more than 2 volts is used as the first switching element whose gate voltage threshold is the first predetermined value, switching of the power conversion device can be performed with low loss or with high carrier frequency.

There is an advantage that a second switching element whose gate voltage threshold is a second predetermined value and a third switching element whose gate voltage threshold is lower than the second predetermined value can be configured at low cost, if IGBT or MOSFET made of silicon is used.

If a unipolar switching device of SiC (silicon carbide) or GaN (gallium nitride) which is a wide bandgap semiconductor is used as a first switching element whose gate voltage threshold is a first predetermined value, switching of the power conversion device can be performed with low loss or with high carrier frequency.

### BRIEF DESCRIPTION OF DRAWINGS

FIG. 1 shows a configuration example of a power conversion device according to Embodiment 1 of the present invention, when applied to a booster chopper circuit.

FIG. 2 shows a configuration example of the power conversion device according to Embodiment 1 of the present invention, when applied to a three-phase inverter circuit.

FIG. 3 shows a configuration example of a power conversion device according to Embodiment 2 of the present invention, when applied to a three-phase inverter circuit.

FIG. 4 shows a configuration example of a power conversion device according to Embodiment 3 of the present invention, when applied to a three-phase inverter circuit.

FIG. 5 shows a configuration example of a power conversion device according to Embodiment 4 of the present invention, when applied to a three-phase inverter circuit.

### MODE FOR CARRYING OUT THE INVENTION

Hereinafter, embodiments of a power conversion device according to the present invention will be described in detail based on the figures. Note that the present invention should not be limited by these embodiments.

### Embodiment 1

FIG. 2 is a power conversion device according to Embodiment 1 of the present invention and shows a configuration example when applied to a three-phase inverter circuit. In FIG. 2, a three-phase AC voltage inputted by an AC power source 20 is rectified by a diode bridge 22 after passing through a switch 21, and the rectified DC voltage is supplied to a capacitor 23. First switching elements 24a and 24b, 25a and 25b, and 26a and 26b whose gate voltage thresholds are a first predetermined value are series-connected, respectively; and the elements 24b, 25b, and 26b and second switching elements 40a, 41a, and 42a whose gate voltage thresholds are a second predetermined value which is higher than the first predetermined value, are series-connected, respectively, to configure each arm serving as a first switch unit. DC power input terminals 33a and 33b for inputting a DC voltage of the capacitor 23 to the first switch units are provided at both ends of the capacitor 23, and three arms are configured by parallel-connecting the first switch units to the capacitor 23 via the DC power input terminals. Each of junctions between the switching elements 24a and 24b, 25a and 25b, and 26a and 26b is connected to a three-phase motor 28. In FIG. 2, an anti-parallel diode serving as a reflux diode for each of the first switching elements is configured with a body diode which is formed in each of the elements 24a, 24b, 25a, 25b, 26a, and 26b whose gate voltage thresholds are the first predetermined value. Incidentally, reflux diodes 40b, 41b, and 42b are anti-parallel-connected to the second switching elements 40a, 41a, and 42a, respectively, whose gate voltage thresholds are the second predetermined value which is higher than the first predetermined value.

A unipolar switching device of SiC (silicon carbide) or GaN (gallium nitride) which is a wide bandgap semiconductor is used as the first switching element whose gate voltage threshold is the first predetermined value so that a switching loss or a conduction loss of the power conversion device will be decreased. A control circuit voltage for operating a control circuit in a second control unit 30a is supplied by a control power source 29 which is connected to the AC power source 20 via the switch 21, and gate drive signals 31a for turning on or off the switching elements 24a, 24b, 25a, 25b, 26a, 26b, 40a, 41a, and 42a are outputted by the second control unit 30a.

In a case in which the switch 21 is turned on, voltage is provided by the AC power source 20 to the capacitor 23 and a voltage necessary for the second control unit 30a is outputted by the control power source 29. If the control circuit voltage outputted by the control power source 29 exceeds a predetermined value enough for normally operating an internal circuit of the second control unit 30a, the gate drive signals 31a are outputted by the second control unit 30a in a manner that one is turned on and the other is turned off in each of the combinations of the switching elements 24a and 24b, 25a and 25b, and 26a and 26b, each of which are series-connected to the second control unit 30a so that a desired voltage will be applied to the three-phase motor 28. Here, the gate voltage threshold of each of the switching elements 24a, 24b, 25a, 25b, 26a, and 26b is the first predetermined value, and the value is a low voltage, i.e. no more than 2 volts.

Therefore, a positive polarity voltage is outputted by the second control unit 30a as the gate drive signals 31a for turning on the switching elements. Instead, a negative polarity voltage is outputted by the second control unit 30a as the gate drive signals 31a for turning off the switching elements so that the switching elements will be surely kept OFF.

If the control circuit voltage outputted by the control power source 29 exceeds the predetermined value, the gate drive signals 31a are outputted by the second control unit 30a so that the switching elements 40a, 40b, and 40c will become ON. Instead, if the output voltage of the three-phase AC power source 20 decreases or the switch 21 is turned off, the output voltage of the control power source 29 gradually decreases. Since the control circuit voltage outputted by the control power source 29 is monitored by the second control unit 30a, if the control circuit voltage falls below a predetermined value, the gate drive signals 31a are outputted so that the switching elements 40a, 41a, and 42a will be turned off.

In a conventional art described above, the second switching elements 40a, 41a, and 42a whose gate voltage thresholds are the second predetermined value which is higher than the first predetermined value, are not provided. Therefore, in a case that a residual voltage is left at both ends of the capacitor 23 when the control circuit voltage, outputted by the control power source 29, of the second control unit 30a becomes zero, if two switching elements, out of the first switching elements 24a, 24b, 25a, 25b, 26a, and 26b whose gate voltage thresholds are the first predetermined value, which are series-connected with each other, for example the switching elements 24a and 24b, are turned on by malfunction due to noise, etc., the first switching elements are destroyed since an excessive current flows through the switching elements due to a short-circuit of the capacitor 23.

In addition, instead of the two switching elements which are series-connected as described above, in a case that an upper side switching element of an arm and a lower side switching element of another arm, for example the switching elements 24a and 25b, are simultaneously turned on, if the switching elements are concurrently turned on for a long time, these switching elements are destroyed since a current flowing through the switching elements via the three-phase motor 28 increases. Especially, in a case that the gate voltage threshold of the switching elements 24a, 24b, 25a, 25b, 26a, and 26b is no more than zero voltage, although zero voltage is outputted as the gate drive signals 31a because the output voltage of the control power source 29 decreases and the control circuit voltage of the second control unit 30a becomes zero voltage, the first switching elements 24a, 24b, 25a, 25b, 26a, and 26b become ON. Therefore, the first switching elements are easily destroyed since an excessive current flows through the switching elements due to a short-circuit of the capacitor 23 even if there is no influence of noise, etc.

However, in the three-phase inverter circuit according to Embodiment 1 of the present invention shown in FIG. 2, because the excessive current flowing through the switching elements is interrupted by the second switching elements 40a, 41a, and 42a whose gate voltage thresholds are the second predetermined value which is higher than the first predetermined value, it is possible to avoid the destruction of the switching elements caused by the above described malfunctional turning on of the switching elements 24a, 24b, 25a, 25b, 26a, and 26b.

In the embodiment, an example is shown in which the control circuit voltage outputted by the control power source 29 is monitored by the second control unit 30a and, if the voltage falls below the predetermined value, the gate drive signals 31a are outputted so that the second switching elements 40a, 41a, and 42a will be turned off. However, control by the second control unit 30a may be performed so that the second switching elements 40a, 41a, and 42a will be turned off when the first switching elements 24a, 24b, 25a, 25b, 26a, and 26b are turned off even if there is no drop in the control circuit voltage.

Furthermore, while the anti-parallel diode serving as the reflux diode is configured, in FIG. 2, with the body diode which is formed in each of the first switching elements 24a, 24b, 25a, 25b, 26a, and 26b whose gate voltage thresholds are the first predetermined value, it is needless to say that an effect similar to that described above can be obtained by anti-parallel-connecting another diode to each of the above described switching elements so that the another diode will have the same function as the reflux diode. In addition, while the second switching elements 40a, 41a, and 42a whose gate voltage thresholds are the second predetermined value other than the first predetermined value are provided at the lower side of the arms, the second switching elements may be provided at the upper side of the arms, and it is needless to say that a similar effect can be obtained if the elements are provided at a position where the current from the capacitor 23 can be interrupted. Still further, it is needless to say that an effect similar to that described above can be obtained by employing a configuration such that, in the three arms, a second switching element whose gate voltage threshold is the second predetermined value which is higher than the first predetermined value is provided at the upper side of an arm and another second switching element whose gate threshold voltage is the second predetermined value which is higher than the first predetermined value is provided at the lower side of another arm.

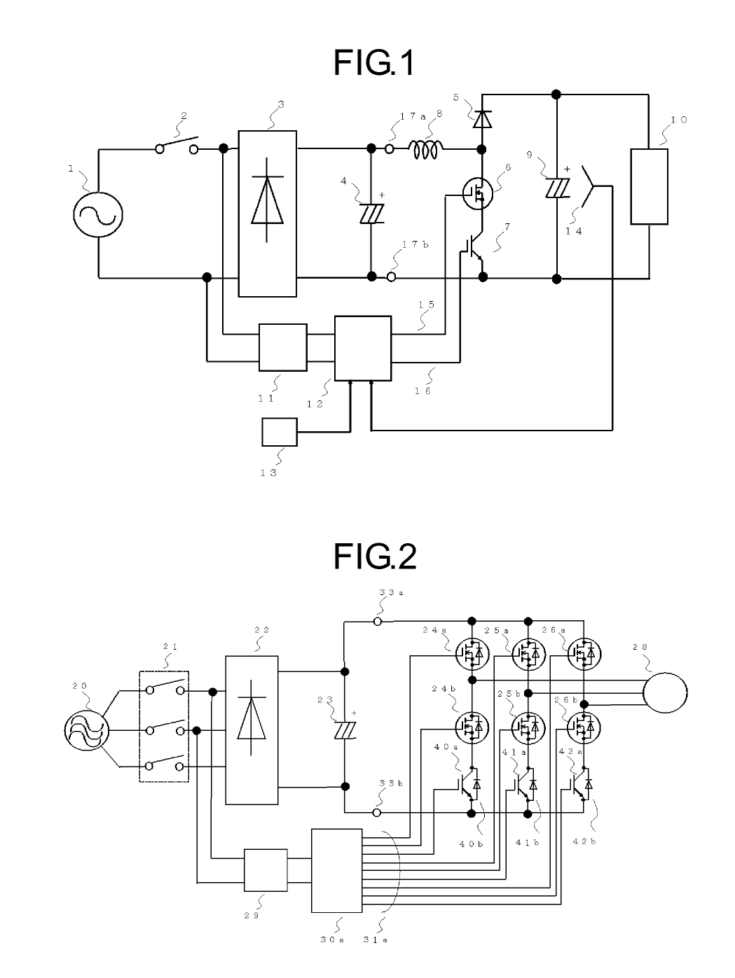

FIG. 1 is a power conversion device in a working example, other than the above described one, according to Embodiment 1 of the present invention and shows a configuration example when applied to a booster chopper circuit. In FIG. 1, an AC voltage inputted by an AC power source 1 is rectified by a diode bridge 3 after passing through a switch 2, and the rectified DC voltage is supplied to a capacitor 4. A first switch unit is configured by series-connecting a first switching element 6 whose gate voltage threshold is a first predetermined value and a second switching element 7 whose gate voltage threshold is a second predetermined value which is higher than the first predetermined value. DC power input terminals 17a and 17b for inputting a DC voltage of the capacitor 4 to the first switch unit are provided at both ends of the capacitor 4, and output terminals 18a and 18b for outputting a voltage from the booster chopper circuit to a load are provided at both ends of a capacitor 9.

As for a circuit in which the first switch unit and a diode 5 are series-connected, a cathode of the diode 5 and a positive electrode side of the capacitor 9 are connected, and a terminal of the second switching element 7 which is located opposite to a switching element 6 connected side in the first switch unit is connected to a negative electrode side of the capacitor 8. An end of a coil 8 and the input terminal 17a are connected, and another end of the coil 8 and an anode of the diode 5 are connected. A positive electrode terminal of the capacitor 9 and the output terminal 18a are connected; and a negative side terminal of the capacitor 9, the input terminal 17b, the terminal of the second switching element 7 which is located opposite to the switching element 6 connected side, and the output terminal 18b are connected. Loading equipment 10 such as an inverter circuit, a resistor, or a battery is connected between the output terminals 18a and 18b.

A control circuit voltage for operating a control circuit in a first control unit 12 is provided by a control power source 11 connected to the AC power source 1 via the switch 2. An output from a DC voltage command setting section 13 and a voltage of the capacitor 9 detected by a DC voltage detection section 14 are inputted to the first control unit 12, and a gate drive signal 15 for the first switching element 6 and a gate drive signal 16 for the second switching element 7 are outputted by the first control unit 12.

If the switch 2 is turned on, an AC voltage from the AC power source 1 is converted into a DC voltage by the control power source 11, and then the DC voltage necessary for the first control unit 12 is outputted. When the switch 2 is turned on and the DC voltage necessary for the first control unit 12 is outputted. Outputted by the first control unit 12 are the gate drive signal 15 whose pulse-width is controlled so that a DC voltage command value of the capacitor 9 set by the DC voltage command setting section 13 will coincide with a voltage between both terminals of the capacitor 9, and the gate drive signal 16 of always-on.

As for the gate drive signal 15 for the first switching element 6 whose gate voltage threshold is the first predetermined value, a positive polarity voltage is outputted for turning on the output of the first switching element 6, and a negative polarity voltage, instead, is outputted for turning off so that the switching element 6 will be surely kept OFF. As for the gate drive signal 16 for the second switching element 7 whose gate voltage threshold is the second predetermined value which is higher than the first predetermined value, a positive polarity voltage is outputted for turning on the output of the switching element 7, and a negative polarity voltage or zero voltage, instead, is outputted for turning off.

If the switch 2 is turned off, an output voltage of the control power source 11 is gradually decreased. Since the control circuit voltage inputted by the control power source 11 is monitored by the first control unit 12, if the control circuit voltage falls below a predetermined value, the gate drive signals 15 and 16 are outputted so that the outputs from the first switching element 6 and the second switching element 7 will be turned off, respectively.

That is, a negative polarity voltage is outputted as the gate drive signal 15, and a negative polarity voltage or zero voltage is outputted as the gate drive signal 16.

If the control circuit voltage of the first control unit 12 becomes zero voltage as the output voltage of the control power source 11 is further decreased, the gate drive signal 15 whose outputted voltage has had a negative polarity also becomes zero voltage. In such a case, the gate voltage threshold of the first switching element 6 is the first predetermined value, and the value is a low voltage, i.e. no more than 2 volts. Therefore, if the voltage of the gate drive signal 15 exceeds the gate voltage threshold of the first switching element 6 caused by superposition of noise, etc., the output of the first switching element 6 becomes ON. If the gate voltage threshold of the first switching element 6 is no more than zero voltage, the output of the first switching element 6 which has been turned off becomes ON again at the time when the gate drive signal 15 is decreased to zero voltage, even if there is no superposition of noise.

In a conventional art described above, if a residual voltage is left at both ends of the capacitor 4, an excessive current discharged from the capacitor 4 flows through the first switching element 6 via a reactor 8 because the output of the first switching element 6 becomes ON again, and thus the first switching element 6 is destroyed. However, in the booster chopper circuit according to Embodiment 1 of the present invention shown in FIG. 1, the gate voltage threshold of the second switching element 7 which is series-connected to the first switching element 6 is the second predetermined value which is higher than the first predetermined value. Therefore, it is possible to avoid destruction caused by the malfunctional turning on of the first switching element 6, since the voltage of the gate drive signal 16 does not exceed the gate voltage threshold of the second switching element 7 even if there is superposition of noise and the output of the second switching element 7 is not turned on. In addition, while a problem similar to that described above arises when the voltage of the AC power source 1 is decreased due to a power failure, etc. even if the switch 2 is not provided, it is possible to avoid destruction of the switching element by employing Embodiment 1 in such a case.

Especially, in a case that a switching element whose gate voltage threshold is no more than zero voltage is employed as the first switching element 6, if the control circuit voltage of the first control unit 12 becomes zero voltage due to a decrease in the output voltage of the control power source 11, the output of the first switching element 6 is kept ON although zero voltage is being outputted as the gate drive signal 15. Meanwhile, it is known empirically that, if a switching element whose gate voltage threshold is higher than, generally speaking, 2 volts is employed, malfunction does not occur because the switching element is kept OFF even if noise, etc. is superposed from the outside. Therefore, it is effective if a switching element whose gate voltage threshold is higher than 2 volts is used as the second switching element 7 so that the output of the switching element will be surely turned off when the gate drive signal 16 is zero voltage.

In addition, if a unipolar switching device of SiC (silicon carbide) or GaN (gallium nitride) which is a wide bandgap semiconductor is used as the first switching element 6 whose gate voltage threshold is the first predetermined value, a switching loss can be decreased compared to a case where IGBT, etc. is employed which is a bipolar device.

Because of this, as described above, when a voltage high enough for normally operating the first control unit 12 is outputted by the control power source 11, the pulse-width of the gate drive signal 15 is controlled by the first control unit 12 so that a voltage between both terminals of the capacitor 9 detected by DC voltage detection section 14 will coincide with a DC voltage command value of the capacitor 9 set by the DC voltage command setting section 13. In addition, switching is performed by inputting the gate drive signal 15 to the first switching element 6 whose gate voltage threshold is the first predetermined value, and the second switching element 7 whose gate voltage threshold is the second predetermined value which is higher than the first predetermined value is always kept ON. As a result, since switching loss is generated only in the first switching element 6 whose switching loss is low and whose gate voltage threshold is the first predetermined value, an effect is obtained in which total loss of the circuit can be decreased. Furthermore, for the purpose of suppressing heat generation in the first switching element 6 whose gate voltage threshold is the first predetermined value, switching may be controlled in a manner such that part of switching operations of the first switching element 6 is shared by the second switching element 7 whose gate voltage threshold is the second predetermined value which is higher than the first predetermined value and the second switching element 7 is less frequently switched than the first switching element 6.

Note that positions of the first switching element 6 and the second switching element 7 may be replaced with each other, and an anti-parallel diode may be provided to these elements. Also, a switching element may be used instead of the diode 5. In addition, while a case where the AC power source 1 is a single-phase AC power source is shown in FIG. 1, the AC power source may be a three-phase AC power source or a DC power source such as a battery. Furthermore, while an idea of also detecting a current in the reactor 8 and using it in control is feasible as an internal configuration of the first control unit 12, it is needless to say that such an idea is fully included in the present invention.

Still further, in Embodiment 1 according to the present invention, an example is shown in which the control circuit voltage inputted by the control power source 11 is monitored by the first control unit 12 and, if the voltage falls below the predetermined value, the gate drive signals 15 and 16 are outputted so that the first switching element 6 and the second switching element 7 will be turned off. However, if a circuit configuration is employed such that a switch other than the first control unit 12 is provided and the first switching element 6 and the second switching element 7 are turned off when the switch is turned off, it is also possible, by an operation same with the above described one, to avoid destruction caused by the malfunctional turning on of the first switching element 6 when the voltage of the control power source 11 is decreased.

### Embodiment 2

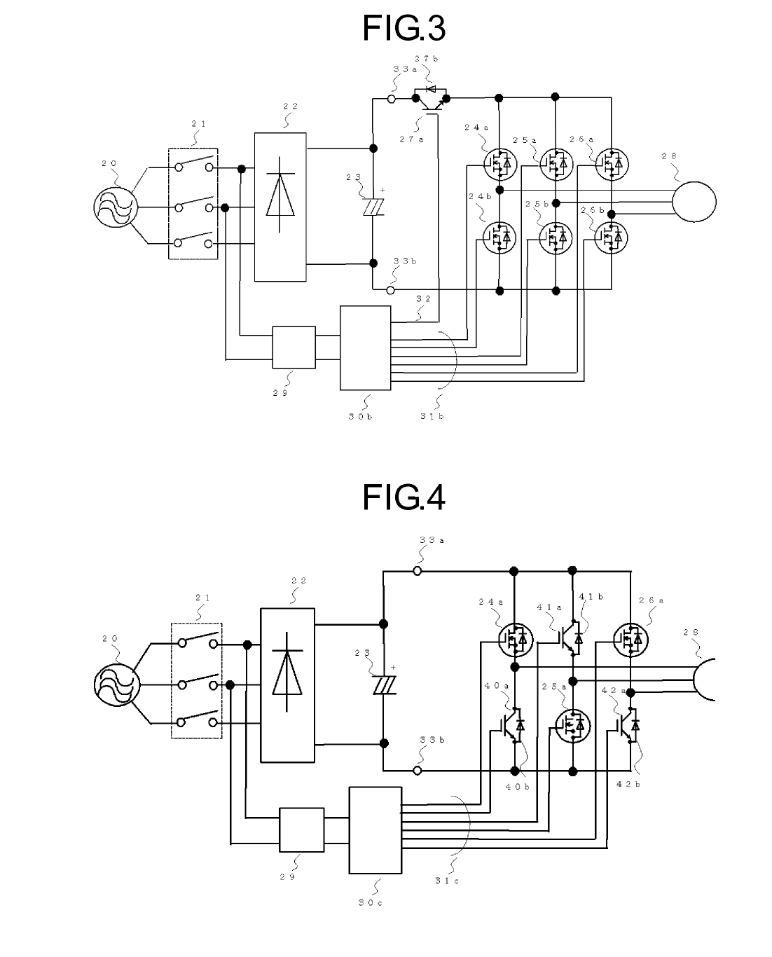

FIG. 3 is a power conversion device according to Embodiment 2 of the present invention and shows a configuration example when applied to a three-phase inverter circuit. Note that components same with those in FIG. 1 are denoted by the same reference numerals and the explanations thereof will be skipped. In FIG. 3, first switching elements 24a and 24b, 25a and 25b, and 26a and 26b whose gate voltage thresholds are a first predetermined value are series-connected, respectively, to configure each arm serving as a second switch unit. DC power input terminals 33a and 33b for inputting a DC voltage of the capacitor 23 to the second switch units are provided at both ends of the capacitor 23, and three arms are configured by parallel-connecting the second switch units to the capacitor 23 via the DC power input terminals. A second switching element 27a whose gate voltage threshold is a second predetermined value which is higher than the first predetermined value is connected between the three arms and the DC power input terminal 33a.

A unipolar switching device of SiC (silicon carbide) or GaN (gallium nitride) which is a wide bandgap semiconductor is used as the first switching elements whose gate voltage thresholds are the first predetermined value so that a switching loss or a conduction loss will be decreased. A control circuit voltage for operating a third control unit 30b is supplied by a control power source 29 which is connected to an AC power source 20 via a switch 21. Outputted by the third control unit 30b are gate drive signals 31b for turning on or off the switching elements 24a, 24b, 25a, 25b, 26a, and 26b, and a switch control signal 32 for turning on or off the second switching element 27a whose gate voltage threshold is the second predetermined value which is higher than the first predetermined value.

If the control circuit voltage outputted by the control power source 29 exceeds a predetermined value, in order to apply a desired voltage to a motor 28, the gate drive signals 31b are outputted by the third control unit 30b in a manner that one is turned on and the other is turned off in each of the combinations of the first switching elements 24a and 24b, 25a and 25b, and 26a and 26b, each of which are series-connected. Here, the gate voltage threshold of each of the switching elements 24a, 24b, 25a, 25b, 26a, and 26b is the first predetermined value, and the value is a low voltage, i.e. no more than 2 volts. Therefore, a positive polarity voltage is outputted by the third control unit 30b as the gate drive signals 31b for turning on the switching elements, and a negative polarity voltage is outputted by the third control unit 30b as the gate drive signals 31b for turning off the switching elements so that the switching elements will be surely kept OFF.

If the control circuit voltage outputted by the control power source 29 exceeds the predetermined value, the switch control signal 32 is outputted by the third control unit 30b so that the second switching element 27a will become ON. Instead, if voltage of a three-phase AC power source 20 decreases or the switch 21 is turned off, the output voltage of the control power source 29 gradually decreases. Since the control circuit voltage inputted by the control power source 29 is monitored by the third control unit 30b, if the control circuit voltage falls below a predetermined value, the switch control signal 32 is outputted so that the second switching element 27a will be turned off. The second switching element 27a is a switching element whose gate voltage threshold is the second predetermined value which is higher than the first predetermined value, and is provided so as to have a polarity of interrupting a current that flows in a direction from a positive side terminal of the capacitor 23 to its junctions with the switching elements 24a, 25a, and 26a. Also, a diode 27b is anti-parallel connected to the switching element 27a.

In a conventional art described above, the switching element 27a is not provided. Therefore, in a case that a residual voltage is left at both ends of the capacitor 23 when the control circuit voltage, outputted by the control power source 29, of the third control unit 30b becomes zero, if two switching elements, out of the first switching elements 24a, 24b, 25a, 25b, 26a, and 26b whose gate voltage thresholds are the first predetermined value, which are series-connected in the arm, for example the switching elements 24a and 24b, are turned on by malfunction due to the influence of noise, etc., the switching elements are destroyed since an excessive current caused by a short-circuit of the capacitor 23 flows through the switching elements.

In addition, in a case that an upper side switching element of an arm and a lower side switching element of another arm, instead of the two switching elements which are series-connected as described above, for example the switching elements 24a and 25b, are simultaneously turned on, if the switching elements are concurrently turned on for a long time, these switching elements are destroyed since a current flowing through the switching elements via the motor 28 increases. Especially, in a case that the gate voltage threshold of the switching elements 24a, 24b, 25a, 25b, 26a, and 26b is no more than zero voltage, although zero voltage is outputted as the gate drive signals 31b because the output voltage of the control power source 29 decreases and the control circuit voltage of the third control unit 30b becomes zero voltage, the first switching elements 24a, 24b, 25a, 25b, 26a, and 26b become ON. Therefore, the first switching elements are easily destroyed since an excessive current caused by a short-circuit of the capacitor 23 flows through the switching elements even if there is no superposition of noise.

However, in the three-phase inverter circuit according to Embodiment 2 of the present invention shown in FIG. 3, provided are the second switching element 27a whose gate voltage threshold is the second predetermined value which is higher than the first predetermined value, and the diode 27b which is anti-parallel connected to the switching element 27a. Therefore, it is possible to interrupt an excessive current flowing into the first switching elements 24a, 24b, 25a, 25b, 26a, and 26b, because the second switching element 27a is turned off if the output voltage of the control power source 29 decreases. In addition, since an operation of the capacitor 23 to absorb regenerative energy from the motor 28 and a surge voltage generated by switching the first switching elements 24a, 24b, 25a, 25b, 26a, and 26b is not disturbed thanks to the diode 27b which is anti-parallel connected to the second switching element 27a, overvoltage of the first switching elements 24a, 24b, 25a, 25b, 26a, and 26b can be prevented. Note that, when a MOSFET is used as the second switching element 27a, the diode 27b may be a body diode formed in a chip in which the second switching element 27a is formed. Further, a switch such as a relay may be employed instead of the second switching element 27a.

In the embodiment shown in FIG. 3, an example is shown in which the control circuit voltage outputted by the control power source 29 is monitored by the third control unit 30b and, if the voltage falls below the predetermined value, the switch control signal 32 is outputted so that the second switching element 27a will be turned off. However, the switch control signal 32 may be outputted by the third control unit 30b based on another determination means, and a configuration may be employed such that the second switching element 27a is turned off when the first switching elements 24a, 24b, 25a, 25b, 26a, and 26b are turned off even if there is no decrease of the control circuit voltage. In addition, while an example is shown in FIG. 3 in which the second switching element 27a is provided between the power input terminal 33a and the positive side terminal of the capacitor 23, the second switching element 27a may be provided between the power input terminal 33b and the negative side terminal of the capacitor 23.

Furthermore, in addition to a portion between the DC power input terminal 33a and the three arms in which the second switch units are parallel-connected, another second switching element 27a and another diode 27b which is anti-parallel connected thereto may be provided at a portion between the power input terminal 33b and the three arms in which the second switch units are parallel-connected. Thus, in a state before the control circuit voltage outputted by the control power source 29 is increased to a voltage enough for operating the third control unit 30b at a startup period of a motor control device such as just after turning on the switch 21, even if an earth fault accident occurs at the motor 28 or wiring thereof, destruction of the first switching elements 24a, 24b, 25a, 25b, 26a, and 26b can be prevented, because both of an earth fault current flowing out through the first switching element 24a, 25a, or 26a, and an earth fault current flowing out through the first switching element 24b, 25b, or 26b can be interrupted. Still further, while an anti-parallel diode serving as a reflux diode is configured with a body diode which is formed in each of the first switching elements 24a, 24b, 25a, 25b, 26a, and 26b whose gate voltage thresholds are the first predetermined value in FIG. 3, it is needless to say that a similar effect can be obtained by configuring a reflux diode by anti-parallel connecting a diode to each of the switching elements.

### Embodiment 3

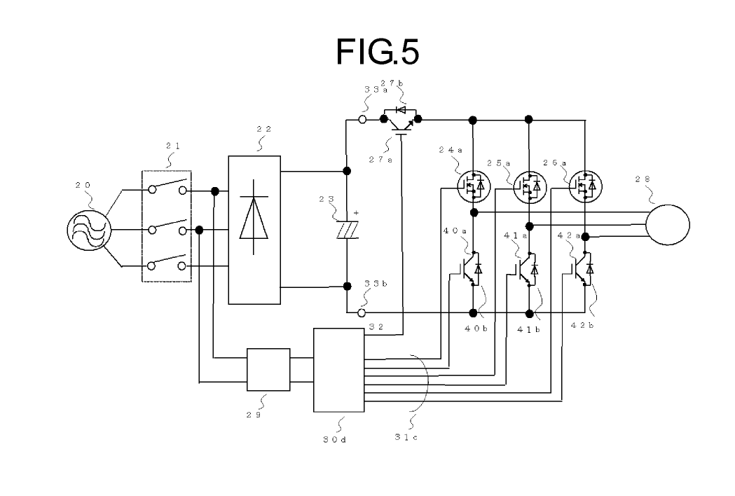

FIG. 4 is a power conversion device according to Embodiment 3 of the present invention and shows a configuration example when applied to a three-phase inverter circuit. Note that components same with those in FIGS. 1 and 3 are denoted by the same reference numerals and the explanations thereof will be skipped. In FIG. 4, a drain terminal of a first switching element 24a whose gate voltage threshold is a first predetermined value is connected to a DC power input terminal 33a, and a source terminal of a second switching element 40a whose gate voltage threshold is a second predetermined value which is higher than the first predetermined value is connected to a DC power input terminal 33b. An arm serving as a third switch unit is configured by series-connecting the first switching element and the second switching element. Similarly, a drain terminal of a first switching element 26a whose gate voltage threshold is the first predetermined value is connected to the DC power input terminal 33a, and a source terminal of a second switching element 42a whose gate voltage threshold is the second predetermined value which is higher than the first predetermined value is connected to the DC power input terminal 33a. Another arm serving as a third switch unit is configured by series-connecting the first switching element and the second switching element.

A drain terminal of a second switching element 41a whose gate voltage threshold is the second predetermined value which is higher than the first predetermined value is connected to the DC power input terminal 33a, and a source terminal of a first switching element 25a whose gate voltage threshold is the first predetermined value is connected to the DC power input terminal 33b. An arm serving as a fourth switch unit is configured by series-connecting the second switching element and the first switching element. Three arms are configured by parallel-connecting the two third switch units and the fourth switch unit, and is parallel-connected to the capacitor 23. Each of junctions between the switching elements 24a and 40a, 41a and 25a, and 26a and 42a is connected to a motor 28.

In FIG. 4, an example is shown where, in the first switching elements 24a, 25a, and 26a, a body diode formed in a chip in which each of the switching elements is formed is used as an anti-parallel reflux diode; and, in the second switching elements 40a, 41a, and 42a, diodes 40b, 41b, and 42b each of which is configured as another chip are anti-parallel connected to the second switching elements 40a, 41a, and 42a, respectively. Note that, as the anti-parallel diode serving as the reflux diode, whether the body diode configured in the chip in which the switching element is formed or the diode configured as another chip is used is not a nature of the present invention, and it makes no difference. A control circuit voltage for operating a fourth control unit 30c is supplied by a control power source 29 which is connected to an AC power source 20 via a switch 21, and gate drive signals 31c for turning on or off the switching elements 24a, 25a, 26a, 40a, 41a, and 42a are outputted by the fourth control unit 30c.

When the switch 21 is turned on, voltage is applied by the AC power source 20 to the capacitor 23 and a voltage necessary for normally operating the fourth control unit 30c is supplied by the control power source 29 to the fourth control unit 30c. If the control circuit voltage from the control power source 29 exceeds a predetermined value, the gate drive signals 31c are outputted by the fourth control unit 30c in a manner that one is turned on and the other is turned off in each of the combinations of the switching elements 24a and 40a, 25a and 41a, and 26a and 42a, each of which are series-connected in the third switch unit or in the fourth switch unit, so that a desired voltage will be applied to the motor 28.

Thus, the first switching element whose gate voltage threshold is the first predetermined value and the second switching element whose gate voltage threshold is the second predetermined value which is higher than the first predetermined value are series-connected; a plurality of switching elements connected to either one of the DC power input terminals 33a and 33b are configured with the switching elements whose gate voltage thresholds are the first predetermined value; and those connected to the other terminal are configured with the second switching elements whose gate thresholds are higher than the first predetermined value. Therefore, even in a case that a residual voltage is left at both ends of the capacitor 23 when the output voltage of the control power source 29 becomes zero, the capacitor 23 is not short-circuited, via the motor 28, by upper and lower switching elements in an arm of one phase or upper and lower switching elements in different arms, because the second switching elements whose gate voltage thresholds are the second predetermined value which is higher than the first predetermined value are surely turned off. As a result, destruction of any one of the above described switching elements can be prevented.

Note that, while a working example in which the three arms are configured by parallel-connecting the two third switch units and the fourth switch unit, and are parallel-connected to the capacitor 23 in FIG. 4, it is needless to say that a similar effect can be obtained if three arms, to be parallel-connected to the capacitor 23, are configured with a third switch unit and two fourth switch units, or configured by grouping together a plurality of third switch units only or a plurality of fourth switch units only.

While a case when applied to the three-phase inverter circuit is described in FIG. 4, it is obvious that a similar effect can be obtained when applied to a single-phase inverter circuit. Also, while a case when the motor is employed as a load for the inverter, it is needless to say that a similar effect can be obtained when a PWM converter is employed to which a reactor and a power source are connected instead of the motor. In addition, it is preferable if a gate drive signal is controlled so that a percentage of conduction time for the first switching element whose gate voltage threshold is the first predetermined value will be larger than that for the second switching element whose gate threshold is the second predetermined value which is higher than the first predetermined value. Thus, a conduction loss caused by the switching element whose gate threshold is higher than the predetermined value can be decreased.

### Embodiment 4

FIG. 5 is a power conversion device according to Embodiment 4 of the present invention and shows a configuration example when applied to a three-phase inverter circuit. Note that components same with those in FIGS. 1, 3, and 4 are denoted by the same reference numerals and the explanations thereof will be skipped. In FIG. 5, a first switching element 24a whose gate voltage threshold is a first predetermined value is connected to a positive electrode side of a DC power input terminal 33a, and a second switching element 40a whose gate voltage threshold is a second predetermined value which is higher than the first predetermined value is connected to a negative electrode side of a DC power input terminal 33b. An arm serving as a third switch unit is configured by series-connecting the first switching element and the second switching element, and a three-phase inverter is configured by parallel-connecting three of the arms. A switching element 27a and a diode 27b which is anti-parallel connected thereto, described in Embodiment 2 according to the present invention, are provided at a portion between the DC power input terminal 33a and an upper side arm portion of each of the third switch units.

Thus, a configuration is employed such that the switching element 27a is provided at the side where the first switching elements whose gate voltage thresholds are the first predetermined value are connected, and the switching element 27a is turned off if an output voltage of a control power source 29 falls below a predetermined value. Therefore, in a state before a control circuit voltage is increased to a voltage enough for normally operating a fifth control unit 30d, such as just after turning on a switch 21, an earth fault current flowing through the first switching elements 24a, 25a, and 26a whose gate voltage thresholds are the first predetermined value can be interrupted, even if an earth fault accident occurs for some reason at a motor 28 or at wiring from a motor control device to the motor 28. As a result, destruction of these switching elements can be prevented. In addition, since an operation of a capacitor 23 to absorb regenerative energy from the motor 28 and a surge voltage generated by switching the switching elements 24a, 25a, 26a, 40a, 412a, and 42a is not disturbed thanks to the diode 27b which is anti-parallel connected to the switching element 27a, overvoltage of the switching elements 24a, 25a, 26a, 40a, 41a, and 42a can be prevented.

Note that a combination of above described embodiments may be employed, and, as a configuration other than the booster chopper or the motor drive inverter described above, technologies based on the above described embodiments can be applied to a power conversion device such as a step-down chopper, a PWM converter circuit, a regenerative converter circuit, a power conditioner for solar cell, or a UPS.

In addition, the diode which is anti-parallel connected to the switching element described in Embodiments 1 through 4 according to the present invention may be a SiC (silicon carbide) device or a GaN (gallium nitride) device which is a wide bandgap semiconductor, or may be a traditional Si device. Further, when a unipolar device is used as a switching element, a parasitic diode formed in a chip in which the unipolar device is formed may be employed.

### REFERENCE NUMERALS

2: switch; 4: capacitor; 11: control power source; 12: first control unit; 21: switch; 23: capacitor; 24a, 24b: switching elements; 25a, 25b: switching elements; 26a, 26b: switching elements; 29: control power source 30a: second control unit; 30b: third control unit; 30c: fourth control unit; 30d: fifth control unit; 33a, 33b: DC power input terminals; 40a, 41a, 42a: switching elements; and 40b, 41b, 42b: reflux diodes.

1. A power conversion device, wherein a switch unit comprised by pairing a first switching element whose gate voltage threshold is a first predetermined value and a second switching element whose gate voltage threshold is a second predetermined value which is higher than the first predetermined value, is connected to a DC power input terminal for inputting a DC voltage to the switch unit; a junction between the first switching element and the second switching element is connected to a load; and a first control unit is provided which controls a gate signal for switching elements so that the number of times for switching the first switching element will be larger than the number of times for switching the second switching element.

2. A power conversion device, wherein a switch unit comprised by pairing a first switching element whose gate voltage threshold is a first predetermined value and a second switching element whose gate voltage threshold is a second predetermined value which is higher than the first predetermined value is series-connected to a third switching element whose gate voltage threshold is lower than the second predetermined value; a series circuit comprised with the switch unit and the third switching element is connected to a DC power input terminal for inputting a DC voltage to the series circuit; a junction between the switch unit and the third switching element is connected to a load; and a first control unit is provided which controls a gate signal for switching elements so that the number of times for switching the first switching element will be larger than the number of times for switching the second switching element.

3. The power conversion device in claim 1, wherein the load is a motor, an AC power source, or a reactor.

4. A power conversion device, wherein the power conversion device is a booster chopper circuit which has an output terminal connected to a load, in which the output terminal is parallel-connected to a circuit where a diode is series-connected to a switch unit comprised by pairing a first switching element whose gate voltage threshold is a first predetermined value and a second switching element whose gate voltage threshold is a second predetermined value which is higher than the first predetermined value, and in which a reactor is connected to a junction between the diode and the switch unit; one terminal of the reactor and one terminal of the switch unit are connected to a DC power input terminal for inputting a DC voltage to the booster chopper circuit; and a first control unit is provided which controls a gate signal for switching elements so that the number of times for switching the first switching element will be larger than the number of times for switching the second switching element.

5. The power conversion device in claim 1, wherein gate drive signals for the first switching element and the second switching element are controlled by the first control unit so that, when a DC voltage enough for normally operating is inputted, an input signal for the first switching element will be set to be always-on and an input signal for a gate terminal of the second switching element is pulse width modulated.

6. A power conversion device comprising:
a switch circuit wherein a plurality of switch units are parallel-connected to a DC power input terminal that applies a DC voltage to the plurality of switch units, each of which has a plurality of first switching elements, which are series-connected, whose gate voltage thresholds are a first predetermined value;
a control unit for controlling the first switching elements to be turned on or off; and
a second switching element, located between the switch circuit and the DC power input terminal, whose gate voltage threshold is a second predetermined value which is higher than the first predetermined value, wherein any one of junctions between the plurality of first switching elements which are series- connected, is connected to a load; and
the control unit, after turning on the second switching element, performs control to turn on or off the first switching element so that a desired voltage will be applied to the load.

7. The power conversion device in claim 6, wherein the second switching element is connected between a positive electrode side of the switch circuit and a positive electrode side of the DC power input terminal.

8. The power conversion device in claim 6, wherein the second switching element is connected between a negative electrode side of the switch circuit and a negative electrode side of the DC power input terminal.

9. The power conversion device in claim 6, wherein the second switching elements are connected between a positive electrode side of the switch circuit and a positive electrode side of the DC power input terminal, and between a negative electrode side of the switch circuit and a negative electrode side of the DC power input terminal.

10. A power conversion device comprising:
a switch circuit wherein a plurality of switch units are parallel-connected to a DC power input terminal that applies a DC voltage to the plurality of switch units, in each of which a first switching element whose gate voltage threshold is a first predetermined value and a second switching element whose gate voltage threshold is a second predetermined value which is higher than the first predetermined value are series-connected; and
a control unit for controlling the first switching elements and the second switching elements to be turned on or off, wherein,
in the switch unit, the first switching element is connected to a positive electrode side of the DC power input terminal and the second switching element is connected to a negative electrode side of the DC power input terminal;
a third switching element whose gate voltage threshold is a third predetermined value which is higher than the first predetermined value is provided between a positive electrode side of the switch circuit and a positive electrode side of the DC power input terminal;
any one of junctions between the first switching elements and the second switching elements which are series-connected is connected to a load; and
the control unit, after turning on the third switching element, performs control to turn on or off the first and second switching elements so that a desired voltage will be applied to the load.

11. The power conversion device of claim 10, wherein third switching elements whose gate voltage threshold is a third predetermined value which is higher than the first predetermined value are provided between a negative electrode side of the switch circuit and a negative electrode side of the DC power input terminal.

12. A power conversion device comprising:
a switch circuit wherein a plurality of switch units are
parallel-connected to a DC power input terminal that applies a DC voltage to the plurality of switch units, in each of which a first switching element whose gate voltage threshold is a first predetermined value and a second switching element whose gate voltage threshold is a second predetermined value which is higher than the first predetermined value are series-connected; and
a control unit for controlling the first switching elements and the second switching elements to be turned on or off, wherein,
in the switch unit, the first switching element is connected to a negative electrode side of the DC power input terminal and the second switching element is connected to a positive electrode side of the DC power input terminal;
a third switching element whose gate voltage threshold is a third predetermined value which is higher than the first predetermined value is provided between a negative electrode side of the switch circuit and a negative electrode side of the DC power input terminal;
any one of junctions between the first switching elements and the second switching elements which are series-connected is connected to a load; and
the control unit, after turning on the third switching element, performs control to turn on or off the first and second switching elements so that a desired voltage will be applied to the load.

13. The power conversion device of claim 12, wherein third switching elements whose gate threshold is a third predetermined value which is higher than the first predetermined value are provided between a positive electrode side of the switch circuit and a positive electrode side of the DC power input terminal.

14. The power conversion device in claim 6, wherein a diode is anti-parallel connected to the second 1 switching element.

15. The power conversion device in claim 10, wherein a diode is anti-parallel connected to the third switching element.

16. The power conversion device in claim 2, wherein the second switching element and the third switching element are switching elements whose gate voltage thresholds are higher than 2 volts.

17. The power conversion device in claim 1, wherein the first switching element is a switching element whose gate threshold voltage is no more than 2 volts.

18. The power conversion device in claim 2, wherein the second switching element and the third switching element are IGBTs or MOSFETs made of silicon.

19. The power conversion device in claim 1, wherein the first switching element is a unipolar switching device of SiC (silicon carbide) or GaN (gallium nitride) which is a wide bandgap semiconductor.

20-25. (canceled)
